(19) United States
(12) Patent Application Publication
(10) Pub. No.: US 2011/0217112 A1
(43) Pub. Date: Sep. 8, 2011

(54) BALL STUD OF BALL JOINT FOR VEHICLE AND METHOD OF MANUFACTURING THE SAME

(76) Inventors: Sang Hoon SEOL, Busan (KR); Young Man Woo, Changwon-si (KR)

(21) Appl. No.: 12/914,140

(22) Filed: Oct. 28, 2010

(30) Foreign Application Priority Data
Mar. 2, 2010 (KR) 10-2010-0018640

(51) Int. Cl. F16C 11/06; B23P 11/00

(52) U.S. Cl. 403/122; 29/509

(57) ABSTRACT

Disclosed herein is a ball stud of a ball joint for a vehicle. The ball stud includes a ball stud body and an auxiliary flange plate. The ball stud body includes a spherical head, a neck provided on the spherical head, a flange provided on the neck, a connection part provided on the flange, and a threaded part which is coaxially provided on the connection part. A thread is formed on the threaded part. The threaded part has an outer diameter greater than a diameter of the connection part. The auxiliary flange plate is fitted over the connection part. A coupling hole is formed through a central portion of the auxiliary flange plate. The coupling hole has a diameter less than the outer diameter of the threaded part. The auxiliary flange plate has a support area greater than a support area of the flange.

### BACKGROUND OF THE INVENTION

1. Field of the Invention

The present invention relates to a ball stud for a ball joint used in a joint unit of a steering system or suspension system of a vehicle and a method of manufacturing the ball stud.

2. Description of the Related Art

Generally, ball joints are used in joint units of steering systems or suspension systems of vehicles.

The ball joints include a ball stud and a ball seat. The ball stud integrally includes a spherical head, a neck, a flange and a threaded part. The spherical head of the ball stud is rotatably seated into the ball seat.

Various kinds of parts of a vehicle are coupled to the threaded part of the ball stud and a nut is tightened over the threaded part. The parts of the vehicle are brought into close contact with the flange of the ball stud.

Here, in the case where a contact area between the flange and the parts of the vehicle is relatively small, noise may be generated at contact portions between the flange and connection parts, and the coupling may be defective.

Therefore, recently there has been a tendency to increase a support area of the flange of the ball stud.

However, the flange and the threaded part of the ball stud are formed at the same time by forging (of course, the threaded part requires a thread-rolling process after the forging process). If the difference in size between the flange and the threaded part is excessively large, the forging process is very complicated.

### SUMMARY OF THE INVENTION

Accordingly, the present invention has been made keeping in mind the above problems occurring in the prior art, and an object of the present invention is to provide a ball stud of a ball joint for a vehicle which can be made by a simple manufacturing process, wherein the ball joint has an increased area for supporting a connection part of the vehicle, and a method of manufacturing the ball stud.

The ball stud of the present invention can markedly increase the area for supporting the connection part of the vehicle, so that problems of the occurrence of noise and defective coupling between the ball stud and the connection part can be solved.

In order to accomplish the above object, in an aspect, the present invention provides a ball stud of a ball joint for a vehicle, including: a ball stud body made of metal, the ball stud body having a spherical head, a neck provided on the spherical head, a flange provided on the neck, a connection part provided on the flange, the connection part having a cylindrical shape, and a threaded part provided on the connection part such that the threaded part is coaxial with the connection part, with a thread formed on the threaded part, the threaded part having an outer diameter greater than a diameter of the connection part; and an auxiliary flange plate fitted over the connection part of the ball stud body, the auxiliary flange plate being made of metal and having a planar shape, with a coupling hole formed through a central portion of the auxiliary flange plate, the coupling hole having a diameter less than the outer diameter of the threaded part, the auxiliary flange plate having a support area greater than a support area of the flange.

In this aspect, a material of the auxiliary flange plate may be softer than a material of the flange.

In another aspect, the present invention provides a method of manufacturing a ball stud of a ball joint for a vehicle, including: forming a ball stud body made of metal, the ball stud body having a flange, a connection part provided on the flange, the connection part having a cylindrical shape, and a threaded part provided on the connection part such that the threaded part is coaxial with the connection part, with a thread formed on the threaded part, the threaded part having an outer diameter greater than a diameter of the connection part; forming a funnel-shaped auxiliary plate made of metal and having a coupling hole on a central portion of a lower end thereof, the coupling hole having a diameter greater than an outer diameter of the threaded part, the funnel-shaped auxiliary plate having a support area greater than a support area of the flange; and inserting the threaded part of the ball stud body into the coupling hole of the funnel-shaped auxiliary plate, and pushing the funnel-shaped auxiliary plate towards the flange of the ball stud body until the central portion of the lower end of the funnel-shaped auxiliary plate comes into contact with the flange, and then pressing the funnel-shaped auxiliary plate supported on the flange into a planar shape, whereby the coupling hole is reduced by the pressing to have a diameter less than the outer diameter of the threaded part.

In this aspect, a material of the auxiliary flange plate may be softer than a material of the flange.

### BRIEF DESCRIPTION OF THE DRAWINGS

The above and other objects, features and advantages of the present invention will be more clearly understood from the following detailed description taken in conjunction with the accompanying drawings, in which:

FIGS. 1 through 3 are views showing a process of manufacturing a ball stud, according to an embodiment of the present invention.

### DESCRIPTION OF THE PREFERRED EMBODIMENTS

Hereinafter, a preferred embodiment of the present invention will be described in detail with reference to the attached drawings, such that those skilled in the art can easily implement the present invention. The present invention is realized in various manners and is not limited to the following embodiment. Furthermore, in the drawings, portions which are not related to the present invention should be omitted to explain the present invention more clearly. Reference should be made to the drawings, in which similar reference numerals are used throughout the different drawings to designate similar components.

In the specification, when the explanatory phrase “a part includes a component” is used, this means that the part may further include the component without excluding other components, so long as special explanation is not given.

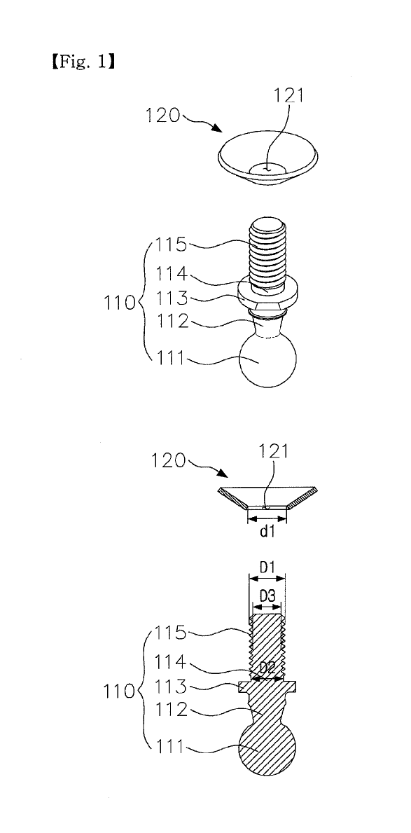

FIGS. 1 through 3 are perspective views and sectional views consecutively showing a process of manufacturing a ball stud 100, according to an embodiment of the present invention.

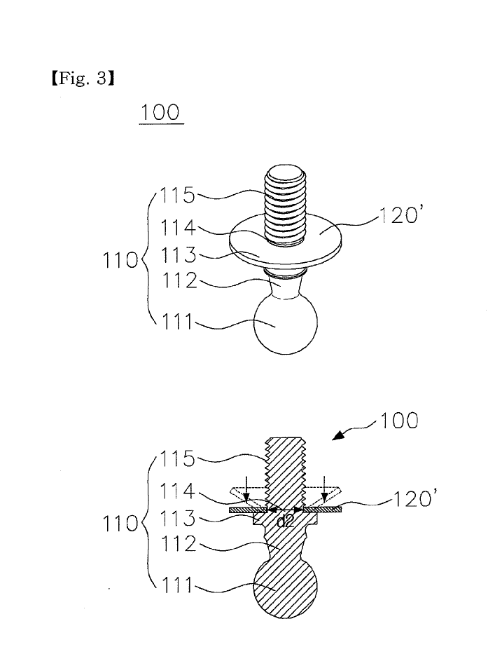

As shown in FIG. 1, the ball stud 100 includes a ball stud body 110 and a funnel-shaped auxiliary plate 120. As shown in FIG. 3, the funnel-shaped auxiliary plate 120 becomes an auxiliary flange plate 120′. The ball stud body 110 integrally includes a spherical head 111, a neck 112, a flange 113, a connection part 114 and a threaded part 115. In detail, the neck 112 is integrally provided on the spherical head 111. The flange 113 is integrally provided on the neck 112. The connection part 114 is integrally provided on the flange 113. The threaded part 115 is integrally provided on the connection part 114. The critical shapes of the spherical head 111, the neck 112, the flange 113, the connection part 114 and the threaded part 115 are integrally shaped by forging. Thereafter, a thread is formed by thread-rolling to form the threaded part 115. According to an embodiment, the spherical head 111, etc. may be separately manufactured by a separate process and then integrally coupled to the ball stud body 110 by welding.

As such, the upper end of the connection part 114 is formed by thread-rolling, thus forming the threaded part 115. Therefore, the connection part 114 has a cylindrical shape, and the threaded part 115 is coaxial with the connection part 114. An outer diameter D1 of the threaded part 115 is greater than a diameter D2 of the connection part 114.

Of course, a root diameter D3 of the thread of the threaded part 115 is less than the diameter D2 of the connection part 114.

The funnel-shaped auxiliary plate 120 has the funnel shape which has a coupling hole 121 in a central portion of a lower end thereof.

A diameter d1 of the coupling hole 121 of the funnel-shaped auxiliary plate 120 is greater than the outer diameter D1 of the threaded part 115, such that the threaded part 115 of the ball stud body 110 is inserted into the coupling hole 121 of the funnel-shaped auxiliary plate 120.

Furthermore, an area of the funnel-shaped auxiliary plate 120 is greater than an area of a support surface of the flange 113.

The ball stud body 110 and the funnel-shaped auxiliary plate 120 are made of metal, but the material of the funnel-shaped auxiliary plate 120 is softer than that of the ball stud body 110, particularly, that of the flange 113.

The reason for this is that the funnel-shaped auxiliary plate 120 must be supported on the flange 113 and formed by pressing later.

In this embodiment, the material of the ball stud body 110 is SCM435 (chrome molybdenum steel) including C of 0.33 to 0.38 wt %, Si of 0.15 to 0.35 wt %, Mn of 0.6 to 0.85 wt %, P of 0.03 wt % or less, S of 0.03 wt % or less, Cr of 0.9 to 1.2 wt % and Mo of 0.15 to 0.3 wt %. The material of the funnel-shaped auxiliary plate 120 is SPCC (cold rolled carbon steel sheet) including C of 0.12 wt % or less, Mn of 0.5 wt % or less, P of 0.04 wt % or less and S of 0.045 wt % or less. However, these metal materials are only one illustrative embodiment of the present invention.

Typically, softness of a metal increases as the carbon content becomes smaller.

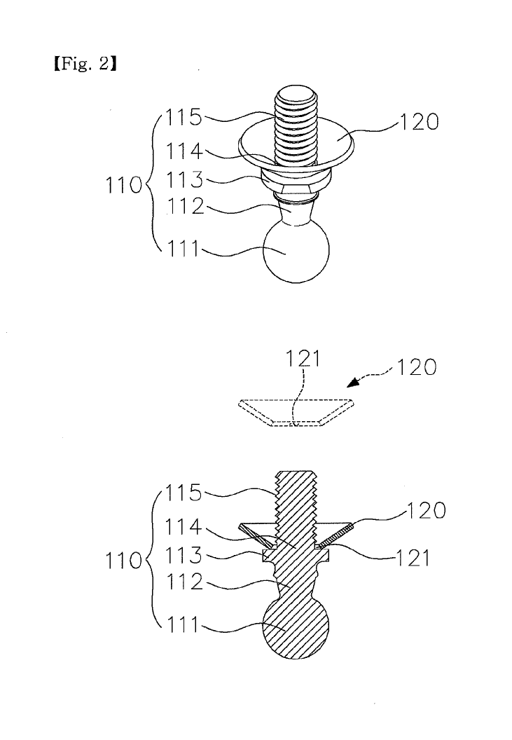

After the ball stud body 110 and the funnel-shaped auxiliary plate 120 are prepared, as shown in FIGS. 2 and 3, the threaded part 115 of the ball stud body 110 is inserted into the coupling hole 121 of the funnel-shaped auxiliary plate 120. Here, the funnel-shaped auxiliary plate 120 is pushed towards the flange 113 of the ball stud body 110 until the central portion of the lower end of the funnel-shaped auxiliary plate 120 comes into contact with the flange 113. Then, as shown in FIG. 2, the coupling hole 121 is disposed at a position corresponding to the connection part 114. Thereafter, the funnel-shaped auxiliary plate 120 is pressed to have a planar shape in the state of being supported on the flange 113.

As such, the funnel-shaped auxiliary plate 120 is formed into the planar auxiliary flange plate 120′ by pressing. At this time, the diameter d1 of the coupling hole 121 is reduced into a diameter d2 by the pressing.

The reduced diameter d2 of the coupling hole 121 is less than the outer diameter D1 of the threaded part 115.

Hereby, the auxiliary flange plate 120′ is firmly fitted over the connection part 114. The auxiliary flange plate 120′ has a support area greater than that of the flange 113.

It is desirable that the diameter d2 of the coupling hole 121 when reduced by the pressing be the same as the diameter D2 of the connection part 114. Thereby, the auxiliary flange plate 120′ can be reliably fastened to the connection part 114.

However, according to an embodiment, the diameter d2 of the coupling hole 121 may be slightly greater than the diameter D2 of the connection part 114. In this case, the diameter d2 of the coupling hole 121 must be less than the outer diameter D1 of the threaded part 115 to prevent the auxiliary flange plate 120′ from being completely removed from the ball stud body 110.

As such, after the auxiliary flange plate 120′ is firmly fastened to the connection part 114, the auxiliary flange plate 120′ can be prevented from being removed from the ball stud body 110 when the ball joint is handled or transferred. Furthermore, an element which is connected to the ball joint can be brought into contact with the auxiliary flange plate 120′ having the comparatively large support area, so that problems of occurrence of noise and defective coupling can be solved.

Moreover, in the present invention, the funnel-shaped auxiliary plate is coupled to the ball stud body after the threaded part has been formed on the ball stud body, in other words, after the thread-rolling process has been completed. Therefore, the auxiliary flange plate does not impede the thread-rolling process which forms the threaded part.

Although the preferred embodiment of the present invention has been disclosed, those skilled in the art will appreciate that various modifications, additions and substitutions are possible, without departing from the scope and spirit of the invention as disclosed in the accompanying claims. Therefore, it should be understood that the preferred embodiment is only for illustrative purposes and does not limit the bounds of the present invention. For instance, components which have been illustrated as being integrated with each other may be implemented in a separate structure, and components which have been illustrated as being separately provided may be provided in an integrated structure.

Therefore, it is intended that the bounds of the present invention are defined by the accompanying claims, and various modifications, additions and substitutions, which can be derived from the meaning, scope and equivalent concepts of the accompanying claims, fall within the bounds of the present invention.

As described above, in the present invention, an auxiliary flange plate in place of a flange is brought into direct contact with a connection part of a vehicle. The auxiliary flange plate has a large area compared to that of the flange. Therefore, problems of the occurrence of noise and defective coupling between a ball stud and the connection part can be solved.

Furthermore, the auxiliary flange plate can be mounted to the ball stud by a very simple method. Thus, the production cost of the ball stud is comparatively low.

In addition, because the auxiliary flange plate is prevented from being removed from the ball stud body, transfer or handling of the ball joint is facilitated.

Moreover, in the present invention, the funnel-shaped auxiliary plate is coupled to the ball stud body after the threaded part has been formed on the ball stud body by thread-rolling. Therefore, the auxiliary flange plate does not impede the thread-rolling process that forms the threaded part.

What is claimed is:

1. A ball stud of a ball joint for a vehicle, comprising:
a ball stud body made of metal, the ball stud body comprising: a spherical head; a neck provided on the spherical head; a flange provided on the neck; a connection part provided on the flange, the connection part having a cylindrical shape; and a threaded part provided on the connection part such that the threaded part is coaxial with the connection part, with a thread formed on the threaded part, the threaded part having an outer diameter greater than a diameter of the connection part; and
an auxiliary flange plate fitted over the connection part of the ball stud body, the auxiliary flange plate being made of metal and having a planar shape, with a coupling hole formed through a central portion of the auxiliary flange plate, the coupling hole having a diameter less than the outer diameter of the threaded part, the auxiliary flange plate having a support area greater than a support area of the flange.

2. The ball stud as set forth in claim 1, wherein a material of the auxiliary flange plate is softer than a material of the flange.

3. A method of manufacturing a ball stud of a ball joint for a vehicle, comprising:
forming a ball stud body made of metal, the ball stud body comprising: a flange; a connection part provided on the flange, the connection part having a cylindrical shape; and a threaded part provided on the connection part such that the threaded part is coaxial with the connection part, with a thread formed on the threaded part, the threaded part having an outer diameter greater than a diameter of the connection part;
forming a funnel-shaped auxiliary plate made of metal and having a coupling hole on a central portion of a lower end thereof, the coupling hole having a diameter greater than an outer diameter of the threaded part, the funnel-shaped auxiliary plate having a support area greater than a support area of the flange; and
inserting the threaded part of the ball stud body into the coupling hole of the funnel-shaped auxiliary plate, and pushing the funnel-shaped auxiliary plate towards the flange of the ball stud body until the central portion of the lower end of the funnel-shaped auxiliary plate comes into contact with the flange, and then pressing the funnel-shaped auxiliary plate supported on the flange into a planar shape, whereby the coupling hole is reduced by the pressing to have a diameter less than the outer diameter of the threaded part.

4. The method as set forth in claim 3, wherein a material of the auxiliary flange plate is softer than a material of the flange.
